(19) United States
(12) Patent Application Publication
(10) Pub. No.: US 2011/0231628 A1
(43) Pub. Date: Sep. 22, 2011

(54) SYSTEM FOR MEMORY INSTANTIATION AND MANAGEMENT

(75) Inventors: Aaron Gelter, West Jordan, UT (US); Brian Parker, West Valley City, UT (US); Robert Boatright, Sandy, UT (US)

(73) Assignee: HARMAN INTERNATIONAL INDUSTRIES, INCORPORATED, Northridge, CA (US)

(21) Appl. No.: 12/826,419

(22) Filed: Jun. 29, 2010

Related U.S. Application Data
(60) Provisional application No. 61/314,373, filed on Mar. 16, 2010.

(51) Int. Cl. G06F 12/02

(52) U.S. Cl. 711/171; 711/E12.007

(57) ABSTRACT

A system for memory instantiation in a programmable logic device (PLD) includes a computing device having a processor and memory coupled with the PLD. The processor is configured to receive memory parameters including at least a data width and a data depth. The processor is also configured to determine a number and sizes of block random access memory (BRAM) primitives required for data storage based on the memory parameters and based on one or more sizes of BRAM primitives available on the programmable logic device. In one example, the processor minimizes a size of the total number of BRAMs required for instantiation on the PLD. The processor is also configured to instantiate the determined number and corresponding sizes of the BRAM primitives in logic for configuration of the programmable logic device to include a device memory within the available BRAM primitives thereof corresponding to the determined number and sizes of the BRAM primitives.

### PRIORITY CLAIM

This application claims the benefit of priority from U.S. Provisional Application No. 61/314,373, filed Mar. 16, 2010, which is incorporated herein by reference.

### BACKGROUND OF THE INVENTION

1. Technical Field

The present disclosure relates generally to programmable logic devices and, in particular, to a system for memory instantiation and management of block RAM on programmable logic devices.

2. Related Art

Programmable logic devices (PLDs) include field-programmable gate arrays (FPGAs), complex programmable logic devices (CPLDs), programmable array logic (PLAs), and generic array logic (GALs), among others, including reconfigurable systems. The PLDs are integrated circuits designed to be configured by a customer or designer after manufacturing. The PLD configuration is generally specified using a hardware description language (HDL), similar to that used for an application-specific integrated circuit (ASIC). PLDs may be used to implement any logical function that an ASIC could perform. The ability to update the functionality after shipping, partial re-configuration of the design, and the low non-recurring engineering costs relative to an ASIC design offer advantages for many applications in which PLDs are used.

PLDs contain programmable logic components called “logic blocks,” and a hierarchy of reconfigurable interconnects that allow the blocks to be wired together—somewhat like a one-chip programmable breadboard. Logic blocks can be configured to perform complex combinational functions, or merely simple logic gates like AND and XOR. In most PLDs, the logic blocks also include memory elements, which may be simple flip-flops or more complete blocks of memory.

At least some PLDs include multiple blocks of random access memory (RAM), otherwise referred to as block RAM (BRAM) primitives, or simply “BRAMs” for simplicity. A BRAM is a dedicated, configurable memory with address, data, and control ports. The BRAM primitives provide ready-to-use, discrete sizes of RAM that may be programmed as part of the PLD configuration process. The RAM is the fastest type of memory storage accessible by processing logic of computing devices, and may be non-volatile memory, and therefore reconfigurable and persistent. The BRAM may be of various storage capacity sizes, such as 18 kB and 36 kB, for instance, depending on the architecture of the device. For instance, Xilinx of San Jose, Calif. has different BRAM primitives for its Spartan® and Virtex® FPGA families. The BRAM may also be of different configurations to include either a single control port, or a dual control port configuration. Each control port may have its own data input, data output, address bus, and clock.

When memories are needed in PLD designs, one of three approaches is typically selected. The first approach is to create a core using a core generation tool such as Coregen by Xilinx. The downside to this approach is that core generation needs to be done for each memory and the highly-specialized cores start to add up and it gets confusing which core to use and where to use the cores on the PLD. Also, if the design specifications change, then someone with intimate knowledge of the design must re-generate a suitable core to match the new design. The second approach is to use electronic circuit design tools, such as behavioral Verilog, to infer the memory. The problem with this approach is that it is difficult to be certain whether the tools will infer BRAM (dedicated logic) or distributed RAM (slice logic). Distributed RAM includes logic structures that could otherwise be used for other purposes and is usually used only when a small, discrete amount of RAM is required, such as for 16-32 elements. BRAM, in contrast, provides larger blocks of dedicated hardware in which to configure block RAM. There are also some cases where the correct BRAM structure is impossible to infer from code.

The third approach is to directly instantiate BRAM primitives in the PLDs. When “instantiated” or some derivation thereof is used herein, it is with reference to the inclusion of instances of logic modules or submodules in HDL source code and the interconnection thereof to each other or to other related logic so as to create a functional design. Instantiation will be explained in more detail below. With the third approach, the use of BRAM logic is assured. The design is no longer portable, however, because the BRAM primitives are PLD-specific: using a different PLD would require code changes. Also, if more than one BRAM primitive is needed, the addressing and select logic for the memory array would have to be written from scratch for every new BRAM primitive needed. The addressing needed to multiplex between the multiple BRAMs also becomes quite complicated, and new BRAMs could be required as the PLD design expands for any reason. These disadvantages carry unacceptable inefficiencies for most commercial applications of PLDs. Without a memory management system, disclosed below, a lot of design time is required when a scheme for accessing multiple BRAM primitives with a single address bus is needed at one or more points within a design.

### SUMMARY

Accordingly, memory instantiation and management within programmable logic devices (PLDs) may be accomplished using a memory management system. The memory management system may be an automated system that can handle memory addressing and data management in memory structures of the PLDs such as in block RAM (BRAM) primitives. Direct instantiation by a designer of architecture-specific primitives for memory addressing and data management within a memory structure may be avoided.

The memory management system may include or be used in conjunction with an electronic design tool. Such electronic design tools may be used for verification of circuit designs through simulation, for timing analysis, for test analysis, and for logic synthesis. In one example, the memory management tool may include an electronic circuit design tool module in the form of a hardware description language providing a textual format for describing electronic circuits and systems, such as a Verilog-based module. The electronic circuit design tool may be used to abstract away the low-level details of BRAM instantiation and address/data management, and provide a high-level, easy-to-use interface. Leveraging the electronic circuit design tool, the memory management system may be used to instantiate and manage any memory structure for any corresponding PLD. In one example, the memory management system may be used to provide standardized and repeatable automated BRAM instantiation and management related to field programmable gate array (FPGA) devices.

The automated BRAM instantiation and management may be parameterized: the system may receive a number of memory parameters, derive the memory parameters from global design parameters, or simply use default memory parameters in the absence of user-specified or system-derived parameters. The memory parameters may include at least a data width and a data depth required from the BRAMs, where the system may derive an address width from the data depth needed for addressing the BRAMs. The system may then determine a number and the sizes of BRAM primitives required for data storage based on the data width and the data depth, and perhaps other parameters, including one or more sizes of a number of BRAM primitives available on the PLD. The system may then instantiate the determined number and corresponding sizes of the BRAM primitives in logic for configuration of the PLD within the available BRAM primitives of the PLD corresponding to the determined number and sizes of the BRAM primitives. The system may be configured to minimize a size of the number of BRAMs on the PLD based on the memory parameters by choosing the smallest number and sized BRAM primitives required to handle the data width and the data depth.

Furthermore, the system may instantiate, in logic, the address and data multiplexing between two or more BRAM primitives with which the PLD may be configured for addressing and data multiplexing the two or more BRAM primitives on the PLD. After compilation, compiled address/data multiplexing logic may then be sent to the PLD for use during configuration of the memory within the required BRAM primitives, which will ensure proper management of the memory by the PLD.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example of a system for memory instantiation and subsequent management.

FIG. 2 is a block diagram of an example of a programmable logic device (PLD) whose block RAM (BRAM) primitives may be instantiated, configured, and managed by the system of FIG. 1.

FIG. 3 is a flow chart of data flow through the system of FIG. 1 by which the system determines local memory parameters and compiles code based on the memory parameters to instantiate the BRAM primitives of a PLD.

FIGS. 4 and 5 are block diagrams of the system of FIG. 1 including an example BRAM selector and set of BRAM primitives to exemplify control logic of addressing and data multiplexing the BRAMs of the example PLD shown in FIG. 2.

FIG. 6 is a flow chart of an example method for memory instantiation and management as disclosed herein and executable by the system of FIG. 1.

FIG. 7 is a general computer system, which may represent any of the computing devices referenced herein.

### DETAILED DESCRIPTION OF THE PREFERRED EMBODIMENTS

By way of introduction, the present disclosure relates to the instantiation of memory structures or blocks on programmable logic devices (PLDs). A memory management system, discussed in detail below, may automate the choice of which of a number of memory structures should be used, and if more than one is needed, to include the addressing and data multiplexing required to manage the instantiated memory in a way transparent to the end user of the PLD, regardless of the number of memory structures required. The end user may be a designer that may reconfigure the PLD without needing to understand the lower-level PLD design and without need to directly reconfigure the memory structures. The instantiation and memory management required by any given PLD design may be developed as part of the logic generated at the time of compilation of hardware description language (HDL) code in a system used to design, instantiate, and configure the logic blocks and interconnects of the PLD.

As discussed previously, to “instantiate” herein refers to the inclusion of instances of logic modules or submodules (including memory) in the HDL source code and the interconnection thereof to each other or to other related logic so as to create a functional design. These instantiations still exist when the source code is compiled and the final compiled result is sent to the PLD to effect configuration of the PLD. The modules or submodules themselves may instantiate (or include) other logic modules which may also include ports to facilitate inputs and outputs, thus making possible a hierarchical relationship between some modules, as instantiated or after being interconnected.

The PLDs may include, for instance, field-programmable gate arrays (FPGAs), complex programmable logic devices (CPLDs), and programmable array logics (PALs), among others. The memory structures referred to herein may also be referred to as block RAM (BRAM) primitives, or simply “BRAMs” for simplicity, as discussed earlier. A BRAM is a dedicated, configurable memory with address, data, and control ports. The BRAM may be of various storage capacity sizes and different configurations to include either a single control port, or a dual control port configuration. The BRAM primitives provide ready-to-use, discrete sizes of RAM that may be programmed as part of one or more devices being instantiated on the PLDs.

To execute the instantiation and memory management, the user need only input certain parameters with which the disclosed memory management system may operate—or may derive the needed memory parameters—to decide how many and of what sizes of the memory structures provided on the PLD are required to meet at least a required data width and data depth. These memory parameters may themselves be driven by data storage needs based on the PLD design. The system may also be configured to minimize a size of the number of needed memory structures (or BRAM) on the PLD based on the memory parameter requirements of the PLD design. Furthermore, where two or more memory structures are determined as needed, the system may instantiate, in logic, address and data multiplexing between two or more BRAM primitives and send compiled logic for the same to the PLD for configuration therein, thus assuring proper management of the memory structures such that they operate as if they constituted a single block or chunk of memory.

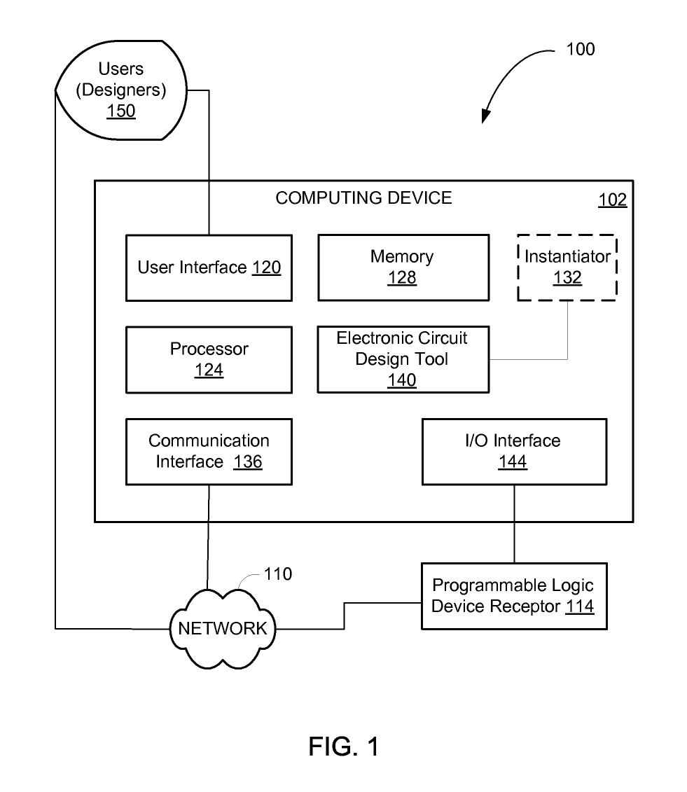

FIG. 1 is a block diagram of an example of a system 100 for memory instantiation and subsequent management. The system may include any sort of computing device 102, perhaps a network 110, and a programmable logic device receptor 114 both coupled with the computing device. Herein, the phrase “coupled with” is defined to mean directly connected to or indirectly connected through one or more intermediate components. Such intermediate components may include both hardware and software based components, including the network 110. The computing device 102 may be a personal computer (PC), client, or server, or some sort of mobile device, including a laptop, having sufficient processing power to run the software required by the system 100.

The computing device 102 may include a user interface 120, a processor 124, a memory 128, an instantiator 132, a communication interface 136 or other network negotiator, an electronic circuit design tool module 140, and an input/output (I/O) interface 144. A user 150, such as a PLD designer, may access the system 100 through the user interface 120 and/or the network 110 and supply thereto parameters needed by the system for memory instantiation and management. The I/O interface 144 may facilitate communication with the programmable logic device receptor 114 in which a PLD may be placed for configuration.

The electronic circuit design tool module 140 may be configured to interact with the processor 124, memory 128, and provide designers using the system 100 a tool from which they may build when creating their own electronic-based product designs and corresponding memory requirements for the PLD, described in more detail later. In one example, the electronic design tool module 140 may include a Verilog compiler. The instantiator 132 may include a module such as a portion of the Verilog compiler, to enable designers to complete the logical instantiation process for configuration of the PLD. Ultimately, compiled Verilog code including the instantiation of the PLD design may be sent to the PLD with which the PLD may configure itself. The instantiator 132, therefore, is optional as a separate module and may simply be incorporated as a part of the electronic circuit design tool module 140. The communication interface 136 may facilitate networked communications, where necessary, for operation of the system 100, either for system access by the user or for system access to the programmable logic device receptor 114.

As described herein, any modules or processing boxes are defined to include software, hardware or some combination thereof executable by the processor 124. Software modules may include instructions stored in the memory 128, or other memory device, that are executable by the processor 124 or other processors. Hardware modules may include various devices, components, circuits, gates, circuit boards, and the like that are executable, directed, and/or controlled for performance by the processor 124.

Designers performing PLD design work may leverage the memory management system 100 to instantiate any number of different electronic devices for any number of different applications uniformly and repeatedly to create standardized memory architectures and memory requirements among electronic circuits and systems employing PLDs such as FPGAs. Because each designer or group of designers working on a particular project will have different design objectives to any reference design—varying bus architectures, buffering requirements, data/address widths, and the like—a design tool may be used to keep designs as generic as possible. Such a design tool may include or be coupled with the electronic circuit design tool module 140 that operates with user-specified or system-derived parameters within the computing device 102. The design tool module 140 may include parameterized Verilog code. By using the design tool module 140 within the memory management system 100, one parameter can be changed high up in a hierarchy of the circuit design and all relevant parts of the design may be automatically adjusted to conform to this change, including changing the memory requirements, such as the instantiation of BRAM primitives within the PLDs.

In one example application, the memory management system may be operated in conjunction with the design of electronic devices and systems containing FPGAs related to audio applications, or audio/video applications. In these applications, designers with different design objectives, such as the number of input/output channels, media interface type, and the like, may similarly keep such designs as generic as possible using the memory management system and associated electronic design tool module.

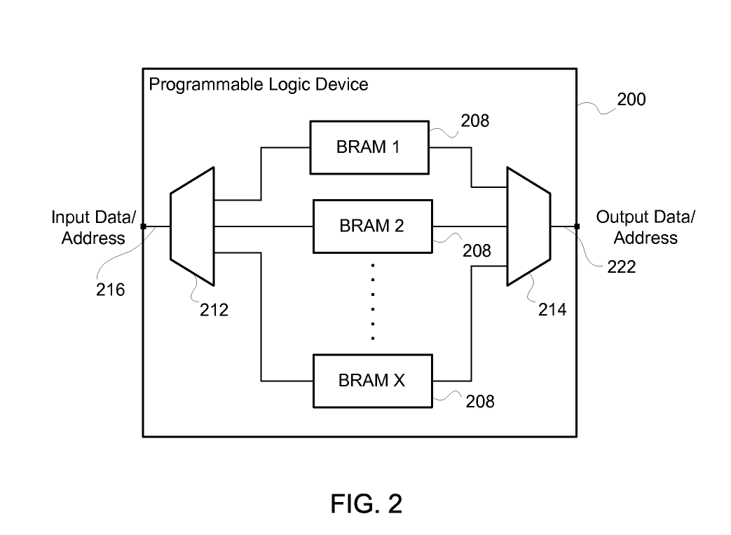

FIG. 2 is a block diagram of an example of a programmable logic device (PLD) 200 whose block RAM (BRAM) primitives 208 may be instantiated, configured, and managed by the system of FIG. 1. The PLD 200 may also include multiplexers 212 and 214 (or other gate technology) controllable by logic compiled for the addressing and data multiplexing required to form two or more BRAMs that operate as a single chunk of memory, as will be explained in more detail later. The PLD 200 also includes an input data/address port 216 and an output data/address port 222 for, respectively, input data and addressing and output data and addressing.

In order to accommodate a parameterized approach to memory instantiation and management, BRAM primitives can be instantiated as architectural building blocks. However, since different manufacturers of FPGA devices may have different primitives for each architecture as discussed previously, as well as different primitives for each BRAM configuration (memory width and depth), there is not a generic instantiation which can be used in all cases. Based on parameters passed into the memory management system, and analysis of the configuration of the electronic design provided from the electronic circuit design tool module, the system 100 may automatically determine the correct low-level primitive that should be used.

When the needed memory data depth requires that multiple BRAMs be instantiated, the addressing needed to multiplex between the multiple BRAMs may become quite complicated. A user may specify the data width and data depth using memory parameters, and the memory management system 100 may automatically instantiate the memory design required to support the data storage and addressing needs of the PLD specified in the memory parameters. More specifically, where more than one BRAM primitive is needed, the system 100 can handle the address and data multiplexing so that the accessing of multiple physical BRAMs is transparent to the user, e.g., to the user, the instantiated memory module appears as a single BRAM.

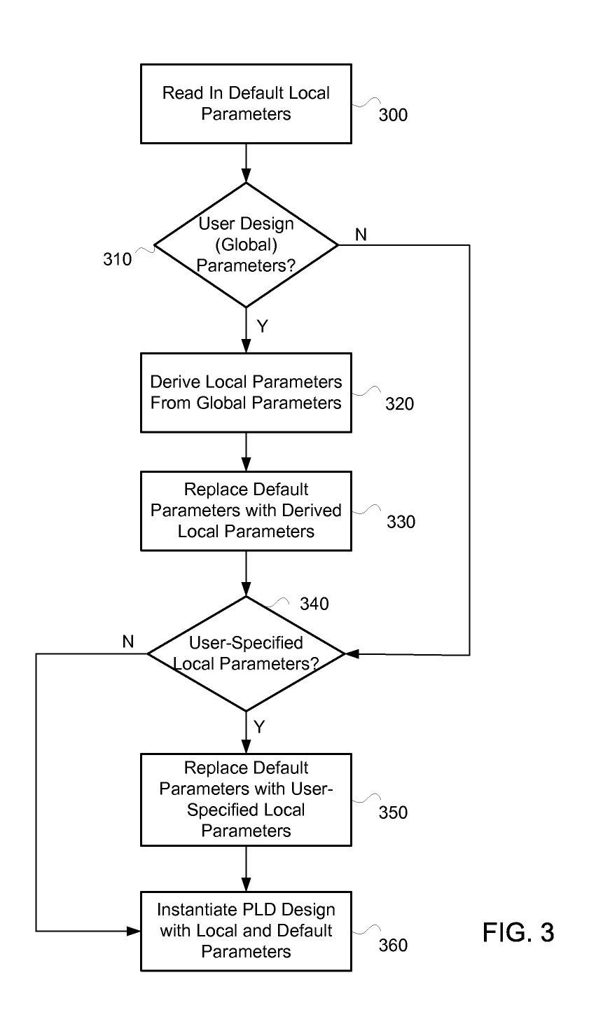

FIG. 3 is a flow chart of data flow through the system of FIG. 1 by which the system determines local memory parameters and compiles instantiation code based on the memory parameters, to instantiate the BRAM primitives of a PLD. The steps of the flow chart do not necessarily happen in a required order but are ordered for ease of explanation. Parameters are what drive how the memory management system 100 configures the needed memory instantiation and addressing. At build time, at block 300, the electronic circuit design tool module 140, such as a Verilog compiler, may read a number of default local parameters passed into the system 100. Default parameters may not provide the most efficient use of the BRAM primitives, but may allow the design tool module 140 to still provide a functional memory instantiation in the absence of other user-specified or system-derived parameters.

At block 310, the system 100 may determine whether the user has specified any design (or global) parameters from which the system 100 may derive local memory parameters. If the user has entered global parameter(s), at block 320, the system 100 may derive the local memory parameters from the global parameters, and at block 330, replace corresponding default parameters with the derived local memory parameters. Whether or not the user has specified global design parameters, the system 100 may, at block 340, determine whether the user has specified any local memory parameters. If the user has entered local memory parameters, at block 350, the system 100 may replace corresponding default memory parameters with the user-specified local parameters. The combination of local parameters entered by the user and default parameters for those not entered by the user may be employed by the system 100, at block 360, to instantiate the requested memory configuration into the PLD design as understood by the electronic circuit design tool 140. While not displayed, the system 100 may then compile the HDL source code to a compiled code to be sent to the PLD for configuration of the PLD, including configuration of the memory structures thereon. The electronic circuit design tool 140 may include a compiler to execute the compilation using the local parameters obtained through the method of FIG. 3.

The global parameters may include user design or higher-level parameters passed in by the user at block 303 that are germane to the PLD design of the designing user. Examples of global parameters may include, but are not limited to, number of channels or streams, such as the audio/video application already mentioned, number of media interfaces, number of media samples per given time period (or input block size), output block size, and sample rate to name a few.

Before compilation, based on the default, derived, and user-specified local parameters, the system 100 may decide how to build (or instantiate) the desired memory configuration as explained herein. Examples of local parameters passed to or derived by the memory management system 100 may include but are not limited to:

DATA_WIDTH_A→designates the data bus width of the data for port A;

DATA_WIDTH_B→designates the data bus width of the data for port B;

DATA_DEPTH→number of data slots, relative to largest of DATA_WIDTH_A and DATA_WIDTH_B;

WRITE_MODE_A→type of write mode to use on port A, one of WRITE_FIRST, READ_FIRST, or NO_CHANGE; and

WRITE_MODE_B→type of write mode to use on port A, one of WRITE_FIRST, READ_FIRST, or NO_CHANGE.

Note that in the case of a single port, DATA_WIDTH_B could be designated as zero, or one of the parameters may include indication of the number of control data ports. Other parameters may include, for instance, address width, pad busses, and the number and sizes of the BRAMs on the PLD depending on architecture. With these example memory parameters, memory configurations may be generated with the memory management system 100 for different families of FPGA architectures, such as Spartan-3, Spartan-6, Virtex-5, and Virtex-6 manufactured by Xilinx. In addition, in other examples, additional parameters may be included to support other architectures such as Altera memories, or any other memory manufacturer of FPGA or other type of PLD.

Some primitives append parity bits to the data bits and use one port for all data while other primitives have separate ports for data and parity. Based on the parameters passed in, the memory management system 100 may decide what is needed and create the correct busses to support the data and parity ports specified by the primitives. The system 100 may also perform checks to make sure that the addresses passed in match the depth requested, and may make adjustments to optimize and enable correct functionality.

In one example, based on the PLD architecture, and thus the number and sizes of BRAMs 208 on the PLD, the data depth, and the data width, along with several calculations performed, the memory management system 100 can instantiate the correct primitive(s), and can automatically instantiate multiple instances of the chosen primitive as needed. This may be done with the use of the functionality included in the electronic circuit design module 140, such as in a Verilog generate structure. Accordingly, one example of the instantiator 132 includes the Verilog generate structure.

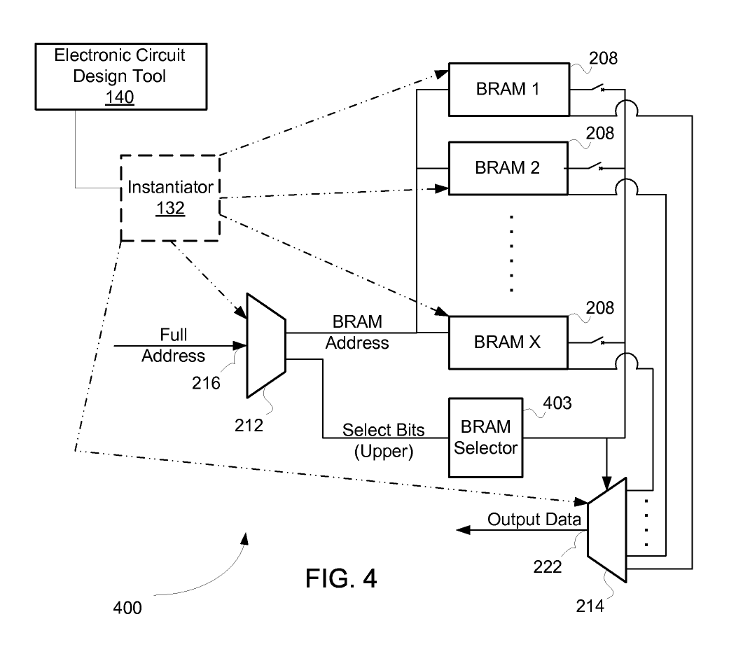

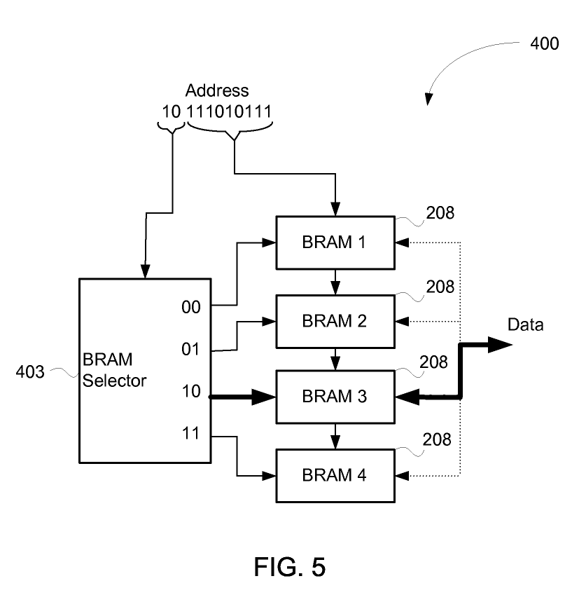

FIGS. 4 and 5 are block diagrams 400 of the system of FIG. 1 including an example BRAM selector 403 and set of BRAM primitives 208 to exemplify control logic of addressing and data multiplexing the BRAMs of the example PLD 200 shown in FIG. 2. The instantiator 132 may include a module such as a portion of the Verilog compiler, to complete the instantiation process of the PLD design based on a determined number and sizes of BRAMs required for a specific design, based on user-entered or system-derived memory parameters. Accordingly, the instantiator 132 may communicate with the electronic circuit design tool module 140 or be integrated therewith to instantiate in logic, within the HDL source code, the BRAM(s) 208 of the required number and sizes as determined by the computing device 102. The computing device 102 may send a compiled version of the instantiation code to the PLD for configuration of the PLD.

Furthermore, the instantiator 132 may also integrate in the instantiation code the control logic required for addressing and data multiplexing the BRAMs as generated by the electronic circuit design tool 140. Accordingly, the instantiation code may define the design of the multiplexers 212 and 214 and the BRAM selector 403 so that a full address at the input address port 216 will provide the BRAM address and the bits required by the BRAM selector 403 to decide which BRAM should be accessed for the given BRAM address. One example of how the system 100 does this is shown in FIG. 5, which is discussed in more detail later. The stored data is always available from the output ports of the BRAMs, but are provided to the output data/address port 222 by a specific BRAM depending on the selected upper bits.

If multiple primitive instantiations are needed to meet the DATA_DEPTH requirement, the memory management system 100 can handle access to these primitives. The address passed in may be automatically parsed, such as by the multiplexer 212, in order to multiplex between the different instantiated BRAMs, all without the user 150 needing to take additional programming steps. As far as the user is concerned, the PLD is instantiating a large BRAM and supplying the wider address bus, as needed. For proper addressing and data multiplexing, the system 100 may pick off a predetermined number of upper address bits, as many as required, and use these upper bits as memory select bits. The upper bits (such as the “10” displayed in FIG. 5) may then be read by the BRAM selector 403 after configuration of the PLD, for selection of the correct BRAM needed to obtain the data at the BRAM address that is read in by the multiplexer 212 (such as the “111010111” shown in FIG. 5). As shown, the BRAM selector 403 may be a state machine that selects a certain BRAM depending on the—in this case two—upper bits passed in with the BRAM address.

More specifically, in one configuration, an array of 2,048 memory locations (11-bit address) is required, but a needed BRAM primitive is only capable of holding 512 of these locations. The memory management system 100 will automatically choose to use four BRAM structures and will address them appropriately in such a way that, to the user, it appears that there is only one large BRAM structure. The least significant 9 bits will be used to address individual BRAMs, and bits 10 and 11 are used to decide which of the 4 BRAMs will be activated and used for any given transaction. For example, address 5D7₁₆=10111010111₂ would access the memories as shown in FIG. 5.

As mentioned, the physical BRAM size can vary architecture to architecture. For example, a Spartan-3 FPGA has 16 Kb BRAMs, while a Spartan-6 has both 9 Kb and 36 Kb BRAMs. This knowledge is not needed by the user, as the memory management system 100 may automatically decide what the most efficient use of memory will be and instantiate the correct primitives. The required memory will be supplied, while minimizing the amount of physical real estate used on the FPGA. As an example, assume a designer requests a data width of 16 bits and a depth of 1500 elements. In a particular FPGA, for instance, there may be two sizes of BRAM available (not including parity bits) for 16 bit data widths: a 512 sized element and a 1024 sized element. Choosing the 1024 element size would use up 2*1024=2048 elements worth of available BRAM resources to reach the desired depth of 1500, where choosing the 512 element size would use 512*3=1536 elements worth of available resources. Choosing the 512 element size is the better choice, so the system 100 would choose it over the 1024 element size. This results in saving an entire 512-element BRAM as compared to the case where the larger 1024 element BRAMs would have been used instead.

Because the width of input and output ports may be at least partially dependent on the parameters passed into the memory management system, it can be difficult to tell the compiler what to expect for port widths. Most electronic circuit design tools, such as Verilog, do not allow the direct use of derived local parameters in port lists. This leaves three options: (1) hard code widths to the widest possible variant; (2) have all port widths be configurable as user-defined parameters; and (3) constant functions.

The issue with option number one is that the compiler will issue warnings if the actual width of a connection does not match the declared width of the port. This results in many unneeded warnings which just confuse the user. Option number two adds confusion to the user because more calculation would be required and information would be supplied which can be inferred from the current parameter list.

The electronic circuit design tool module 140 may be leveraged to employ constant functions in order to enable embedded functions within the memory management system 100 to be called from anywhere in the electronic circuit design tool module 140, as long as all affected values are constant at build time. Using this approach, a constant function can be called from within the port list, which will provide the port width of a signal based on local parameters within the memory management system 100. With this approach, warnings from the compiler may be minimized, and the number of user configurable parameters may be kept to a minimum.

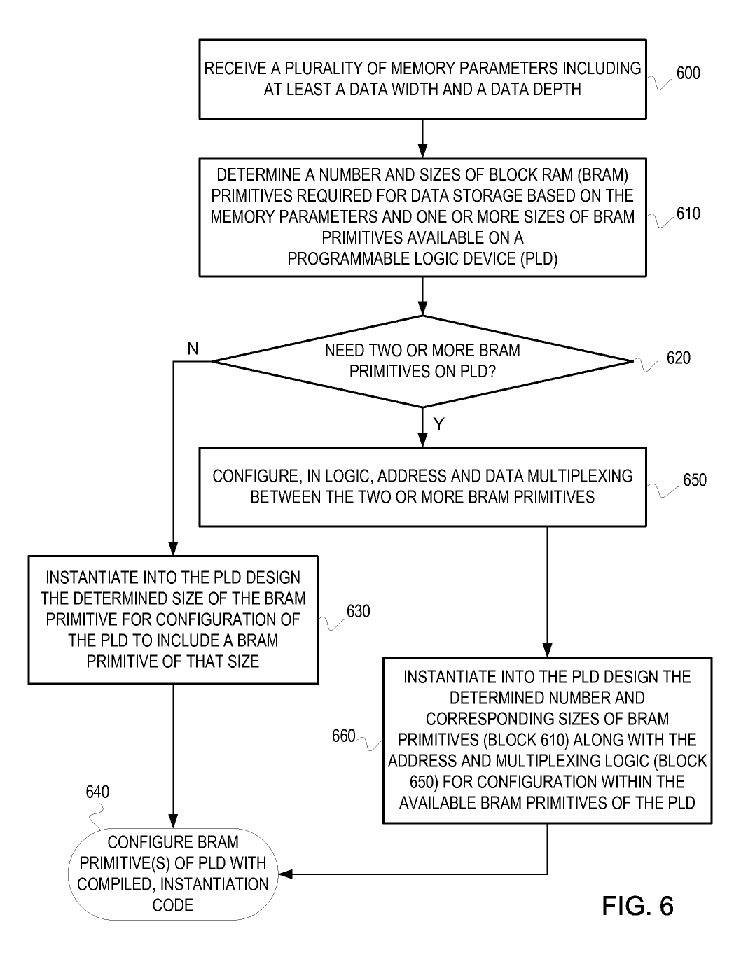

FIG. 6 is a flow chart of an example method for memory instantiation and management as disclosed herein and executable by a computing device 102 having a processor 124 and memory 128 such as that of FIG. 1. The system 100, at block 600, may receive a plurality of memory parameters including at least a data width and a data depth, where an address width is derivable from the data depth. At block 610, the system may determine a number and sizes of block random access memory (BRAM) primitives required for data storage based on the plurality of memory parameters and based on one or more sizes of a plurality of BRAM primitives available on the programmable logic device. At block 620, the system may determine whether, for the PLD design, two or more BRAM primitives are required. If the answer is no, then the system, at block 630, may instantiate into the PLD design the determined size of the BRAM primitive for configuration of the programmable logic device to include a BRAM of that size. At block 640, the system may send a compiled version of the instantiation code to the PLD to configure the PLD with that BRAM primitive.

If the system 100 determines that two or more primitives are needed, the system at block 650 may configure, in logic, address and data multiplexing between the two or more BRAM primitives. At block 660, the system may instantiate into the PLD design the determined number and corresponding sizes of BRAM primitives (from block 610) along with the address and multiplexing logic (from block 650) for configuration within the available primitives of the PLD. At block 640, the system may send a compiled version of the instantiation code to the PLD to configure the PLD with the determined number and sizes of BRAM primitives and with the address and multiplexing logic required to make the memory function as a single block of memory.

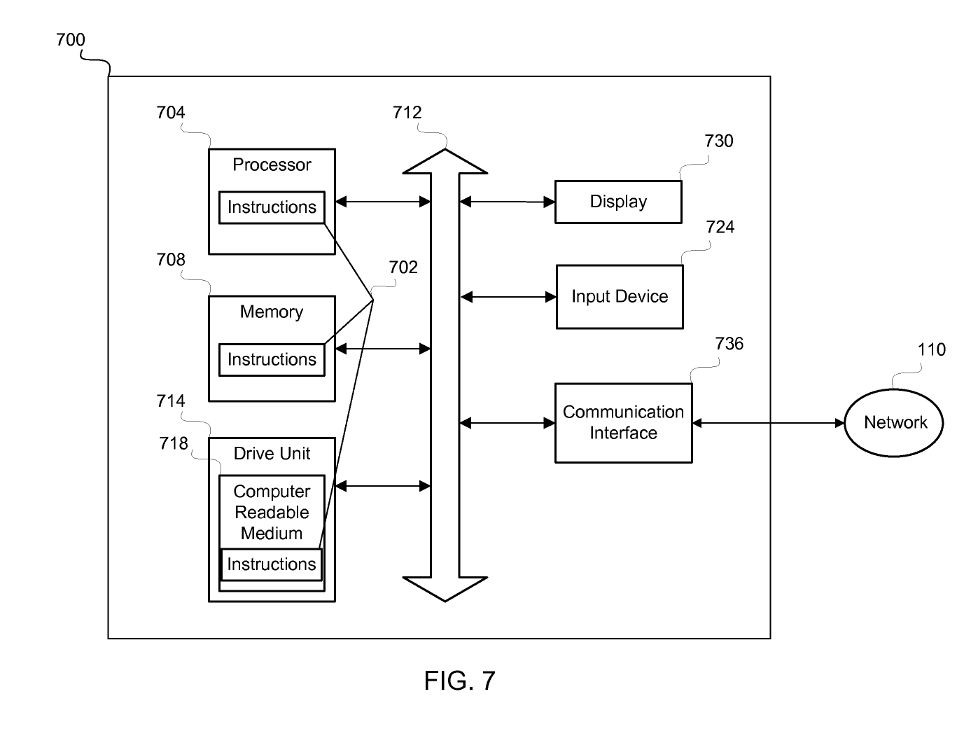

FIG. 7 illustrates a general computer system 700, which may represent the computing device 102, or any other computing devices referenced herein, such as to generate a graphical user interface (GUI) for integration with the user interface 120. The computer system 700 may include an ordered listing of a set of instructions 702 that may be executed to cause the computer system 700 to perform any one or more of the methods or computer-based functions disclosed herein. The computer system 700 may operate as a stand-alone device or may be connected, e.g., using the network 110, to other computer systems or peripheral devices.

In a networked deployment, the computer system 700 may operate in the capacity of a server or as a client-user computer in a server-client user network environment, or as a peer computer system in a peer-to-peer (or distributed) network environment. The computer system 700 may also be implemented as or incorporated into various devices, such as a personal computer or a mobile computing device capable of executing a set of instructions 702 that specify actions to be taken by that machine, including and not limited to, accessing the network 110 through any form of browser. Further, each of the systems described may include any collection of sub-systems that individually or jointly execute a set, or multiple sets, of instructions to perform one or more computer functions.

The computer system 700 may include a processor 704, such as a central processing unit (CPU) and/or a graphics processing unit (GPU). The processor 704 may include one or more general processors, digital signal processors, application specific integrated circuits, field programmable gate arrays, digital circuits, optical circuits, analog circuits, combinations thereof, or other now known or later-developed devices for analyzing and processing data. The processor 704 may implement the set of instructions 702 or other software program, such as manually-programmed or computer-generated code for implementing logical functions. The logical function or any system element described may, among other functions, process and/or convert an analog data source such as an analog electrical, audio, or video signal, or a combination thereof, to a digital data source for audio-visual purposes or other digital processing purposes such as for compatibility for computer processing or networked communication.

The computer system 700 may include a memory 708 on a bus 712 for communicating information. Code operable to cause the computer system to perform any of the acts or operations described herein may be stored in the memory 708. The memory 708 may be a random-access memory, read-only memory, programmable memory, hard disk drive or any other type of volatile or non-volatile memory or storage device.

The computer system 700 may also include a disk or optical drive unit 714. The disk drive unit 714 may include a computer-readable medium 718 in which one or more sets of instructions 702, e.g., software, can be embedded. Further, the instructions 702 may perform one or more of the operations as described herein. The instructions 702 may reside completely, or at least partially, within the memory 708 and/or within the processor 1804 during execution by the computer system 700.

The memory 708 and the processor 704 also may include computer-readable media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 700 may include an input device 724, such as a keyboard or mouse, configured for a user to interact with any of the components of system 700, including user selections or menu entries of display menus. It may further include a display 730, such as a liquid crystal display (LCD), a cathode ray tube (CRT), or any other display suitable for conveying information. The display 730 may act as an interface for the user to see the functioning of the processor 704, or specifically as an interface with the software stored in the memory 708 or the drive unit 714.

The computer system 700 may include a communication interface 736 that enables communications via the communications network 110. The network 110 may include wired networks, wireless networks, or combinations thereof. The communication interface 736 network may enable communications via any number of communication standards, such as Ethernet AVB, 802.11, 802.17, 802.20, WiMax, or other communication standards.

Accordingly, the system may be realized in hardware, software, or a combination of hardware and software. The system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein. Such a programmed computer may be considered a special-purpose computer.

The system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system for memory instantiation in a programmable logic device, the system comprising:
a computing device having a processor and memory coupled with the programmable logic device, the processor configured to:
receive a plurality of memory parameters including at least a data width and a data depth, where an address width is derivable from the data depth;
determine a number and sizes of block random access memory (BRAM) primitives required for data storage based on the plurality of memory parameters and based on one or more sizes of a plurality of BRAM primitives available on the programmable logic device; and
instantiate the determined number and corresponding sizes of the BRAM primitives in logic for configuration of the programmable logic device to include a device memory within the available BRAM primitives thereof corresponding to the determined number and sizes of the BRAM primitives.

2. The system of claim 1, where the processor is configured to minimize a size of the determined number of BRAMs on the programmable logic device based on the plurality of memory parameters.

3. The system of claim 1, where two or more BRAM primitives of one or more predetermined sizes are determined as required and the processor is further configured to:
instantiate, in logic, address and data multiplexing between the two or more BRAM primitives; and
send compiled logic for the address and data multiplexing along with the determined number and sizes of the BRAM primitives to the programmable logic device.

4. The system of claim 3, where the programmable logic device configures the two or more BRAM primitives and data multiplexing based on the compiled logic received from the computing device.

5. The system of claim 3, where the BRAM primitives each require a predetermined number of bits for addressing depending on an architecture of the programmable logic device, the processor configured to select one or more of a plurality of upper bits that exist beyond the predetermined number of bits with which to multiplex for address selection between the two or more BRAMs.

6. The system of claim 3, where the processor is configured to create busses to support data and parity ports specified by the BRAM primitives.

7. The system of claim 3, where the processor is configured to execute a constant function from within a port list of the programmable logic device, the constant function providing a bus width of a port based on the address width.

8. The system of claim 1, where the plurality of memory parameters comprise parameters derived from global design parameters, which are selected based on a device or system in which the programmable logic device will be a part.

9. The system of claim 1, where the plurality of memory parameters include default parameters used by the processor when specific ones of the plurality of memory parameters are not specified by a user.

10. The system of claim 1, where the plurality of memory parameters further comprise an architecture of the programmable logic device.

11. A method for memory instantiation and management in a programmable logic device executable by a computing device having a memory and processor coupled with the programmable logic device, the method comprising:
receiving, by the computing device, a plurality of memory parameters including at least a data width and a data depth;
determining, by the processor, a number and sizes of block random access memory (BRAM) primitives required for data storage based on the plurality of memory parameters and based on one or more sizes of a plurality of BRAM primitives available on the programmable logic device; and
instantiate, by the computing device, the determined number and corresponding sizes of the BRAM primitives in logic for configuration of the programmable logic device to include a device memory within the available BRAM primitives thereof corresponding to the determined number and sizes of the BRAM primitives.

12. The method of claim 11, further comprising the processor minimizing a size of the determined number of BRAMs on the programmable logic device based on the plurality of memory parameters.

13. The method of claim 11, where two or more BRAM primitives of one or more predetermined sizes are determined as required, further comprising the processor:
instantiating, in logic, address and data multiplexing between the two or more BRAM primitives; and
sending compiled logic for the address and data multiplexing along with the determined number and sizes of the BRAM primitives to the programmable logic device.

14. The method of claim 13, where the programmable logic device configures the two or more BRAM primitives based on the compiled logic received from the computing device.

15. The method of claim 13, where the BRAM primitives each require a predetermined number of bits for addressing depending on an architecture of the programmable logic device, the method further comprising the processor:
selecting one or more of a plurality of upper bits that exist beyond the predetermined number of bits with which to multiplex for address selection between the two or more BRAMs.

16. The method of claim 13, further comprising the processor creating busses to support data and parity ports specified by the BRAM primitives.

17. The method of claim 13, further comprising the processor executing a constant function from within a port list of the programmable logic device, the constant function providing a bus width of a port based on an address width derivable from the data depth.

18. The method of claim 11, where the plurality of memory parameters comprise parameters derived from global design parameters, which are selected based on a device or system in which the programmable logic device will be a part.

19. The method of claim 11, where the plurality of memory parameters include default parameters used by the processor when specific ones of the plurality of memory parameters are not specified by a user.

20. The method of claim 11, where the plurality of memory parameters further comprise an architecture of the programmable logic device.

21. A computer-readable storage medium comprising a set of instructions for instantiating and managing memory in a programmable logic device, the set of instructions executable by a computing device having a processor and memory, the computer-readable medium comprising:
instructions to receive a plurality of memory parameters including at least a data width and a data depth, where an address width is derivable from the data depth, in response to signals representative of user inputs through a user interface to input one or more local and global design parameters;
instructions to direct the processor to determine a number and sizes of block random access memory (BRAM) primitives required for data storage based on the plurality of memory parameters and based on one or more sizes of a plurality of BRAM primitives available on the programmable logic device; and
instructions to direct the processor to instantiate the determined number and corresponding sizes of the BRAM primitives in logic for configuration of the programmable logic device to include a device memory within the available BRAM primitives thereof corresponding to the determined number and sizes of the BRAM primitives.

22. The computer-readable storage medium of claim 21, further comprising:
instructions to direct the processor to minimize a size of the determined number of BRAMs on the programmable logic device based on the plurality of memory parameters.

23. The computer-readable storage medium of claim 21, where two or more BRAM primitives of one or more predetermined sizes are determined as required, further comprising:
instructions to direct the processor to instantiate, in logic, address and data multiplexing between the two or more BRAM primitives; and
instructions to direct the processor to send compiled logic for the address and data multiplexing along with the determined number and sizes of the BRAM primitives to the programmable logic device.

24. The computer-readable storage medium of claim 23, where the programmable logic device configures the two or more BRAM primitives based on the compiled logic received from the computing device.

25. The computer-readable storage medium of claim 23, where the BRAM primitives each require a predetermined number of bits for addressing depending on an architecture of the programmable logic device, further comprising:
instructions to direct the processor to select one or more of a plurality of upper bits that exist beyond the predetermined number of bits with which to multiplex for address selection between the two or more BRAMs.

26. The computer-readable storage medium of claim 23, further comprising:
instructions to direct the processor to create busses to support data and parity ports specified by the BRAM primitives.

27. The computer-readable storage medium of claim 23, further comprising:
instructions to direct the processor to execute a constant function from within a port list of the programmable logic device, the constant function providing a bus width of a port based on the address width.

28. The computer-readable storage medium of claim 21, where the plurality of memory parameters comprise parameters derived from the global design parameters, which are selected based on a device or system in which the programmable logic device will be a part.

29. The computer-readable storage medium of claim 21, where the plurality of memory parameters include default parameters used by the processor when specific ones of the plurality of memory parameters are not specified by a user.

30. A system for memory instantiation and management in a programmable logic device, the system comprising:
a computing device having a processor and memory coupled with the programmable logic device;
a user interface coupled with the processor configured to receive a plurality of memory parameters including at least a data width and a data depth, where an address width is derivable from the data depth;
an electronic circuit design tool coupled with the processor and the programmable logic device configured to determine a number and sizes of block random access memory (BRAM) primitives required for data storage based on the plurality of memory parameters and based on an architecture of the programmable logic device; and
the electronic circuit design tool further configured to instantiate the determined number and corresponding sizes of the BRAM primitives in logic for configuration of the programmable logic device such as to minimize a total size of the determined number of BRAMs to be formed on the programmable logic device.

31. The system of claim 30, where two or more BRAM primitives of one or more predetermined sizes are determined as required, where the electronic circuit design tool is further configured to:
instantiate, in logic, address and data multiplexing between the two or more BRAM primitives; and
configure the address and data multiplexing within the programmable logic device for the two or more BRAM primitives, as interconnected.

32. The system of claim 31, where the BRAM primitives each require a predetermined number of bits for addressing depending on the architecture of the programmable logic device, where the electronic circuit design tool is further configured to:
select one or more of a plurality of upper bits that exist beyond the predetermined number of bits with which to multiplex for address selection between the two or more BRAMs.

33. The system of claim 30, where the plurality of memory parameters include one or more sizes of a plurality of BRAM primitives available on the programmable logic device.

34. The system of claim 30, where the plurality of memory parameters include default parameters used by the system when specific ones of the plurality of memory parameters are not specified by a user.
